(19) United States
(12) Patent Application Publication
(10) Pub. No.: US 2009/0176517 A1
(43) Pub. Date: Jul. 9, 2009

(54) Multiple Recipient Messaging Service for Mobile Device

(75) Inventors: Gregory N. Christie, San Jose, CA (US); Marcel MWA van Os, San Francisco, CA (US); Steve Lemay, San Francisco, CA (US); Evan Doll, San Francisco, CA (US); Justin Santamaria, Mountain View, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/969,903

(22) Filed: Jan. 6, 2008

(51) Int. Cl. H04Q 7/22

(52) U.S. Cl. 455/466

(57) ABSTRACT

A messaging application can be activated on a mobile device for determining whether messages were successfully transmitted from the mobile device to one or more specified recipients. The messaging application provides a user interface that allows the user to resend the message to those recipients who did not receive the message or to cancel the message. In one implementation, the state of input text composed for failed messages is retained so that the user does not have to retype the entire message before the message is retransmitted.

### TECHNICAL FIELD

The subject matter of this patent application is generally related to mobile devices and messaging services.

### BACKGROUND

Conventional mobile devices are often dedicated to performing a specific application. For example, a mobile phone provides telephony services, a personal digital assistant (PDA) provides a way to organize addresses, contacts and notes, a media player plays content, email devices provide email communication, a browser to surf the Internet, etc. Modern mobile devices can include two or more of these applications. These modern devices also allow a user to use the telephone services in new ways. A user can, for example, use the short message service (SMS) of the device to send an SMS to more than one recipient. Some devices allow messages to be sent to a group of recipients (e.g., a broadcast).

Messaging networks and/or messaging services may become unavailable or fail for a variety of reasons (e.g., a power outage). If a failure occurs, then a user may have to resend a message from their mobile device that was not delivered to the intended recipients. This can be a tedious process if the message was sent to a group of recipients. Since there is no indication which recipients in the group received the message and which recipients did not receive the message, the user must resend the message to the entire group of recipients. This can result in some recipients receiving duplicate messages which can confuse those recipients. Those recipients may respond to the duplicate messages with additional messages which can add to the confusion caused by the duplicate transmissions.

### SUMMARY

A messaging application can be activated on a mobile device for determining whether messages were successfully transmitted from the mobile device to one or more specified recipients. The messaging application provides a user interface that allows the user to resend the message to those recipients who did not receive the message or to cancel the message. In one implementation, the state of input text composed for failed messages is retained so that the user does not have to retype the entire message before the message is retransmitted.

In some implementations, a method includes: detecting a failed message transmission to a recipient originating on a mobile device, presenting a user interface on the mobile device, including a user interface element which is operable for specifying an option to resend the message to the recipient, receiving user input specifying the resend option, and resending the message to the recipient.

Other implementations are disclosed which are directed to systems, methods and computer-readable mediums.

### DESCRIPTION OF DRAWINGS

FIG. 1A is a block diagram of an example mobile device operable for displaying messages.

FIG. 1B is a block diagram of another example mobile device operable for displaying messages.

FIG. 2A is a block diagram of an example mobile device operable for resending a failed message.

FIG. 2B is a block diagram of another example mobile device operable for resending a failed message.

FIG. 3A is a block diagram of an example mobile device displaying an error report for a failed message transmission.

FIG. 3B is a block diagram of another example mobile device displaying an error report for a failed message transmission.

FIG. 4A is a flow diagram of an example process for resending a failed transmission.

FIG. 4B is a flow diagram of an example process for storing messages in one or more threads.

FIG. 5 is a block diagram of an example mobile device.

FIG. 6 is a block diagram of an example network operating environment for the mobile device of FIG. 5.

FIG. 7 is a block diagram of an example implementation of the mobile device of FIG. 5.

### DETAILED DESCRIPTION

### Resending Messages

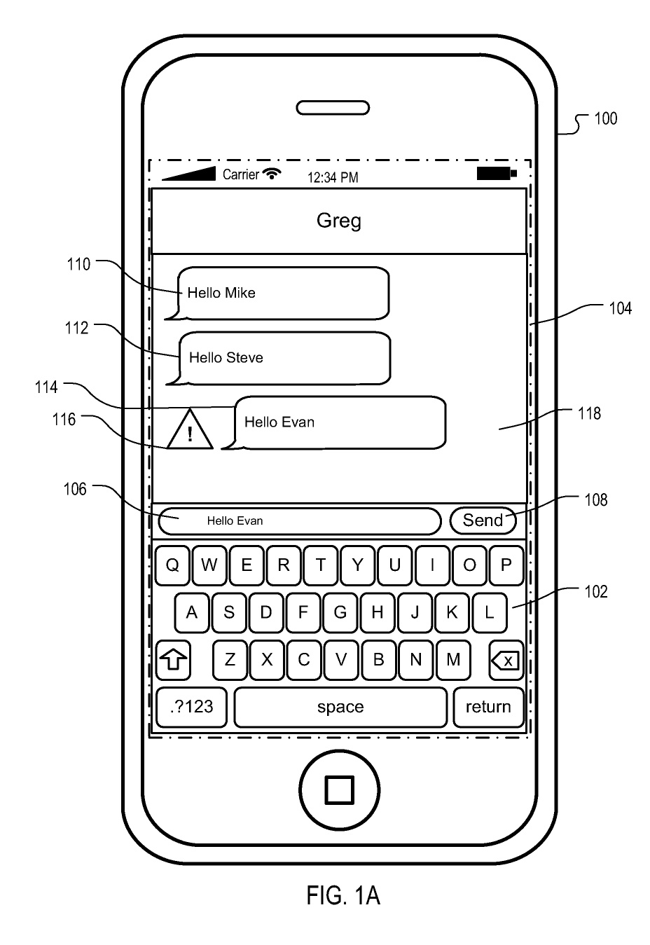

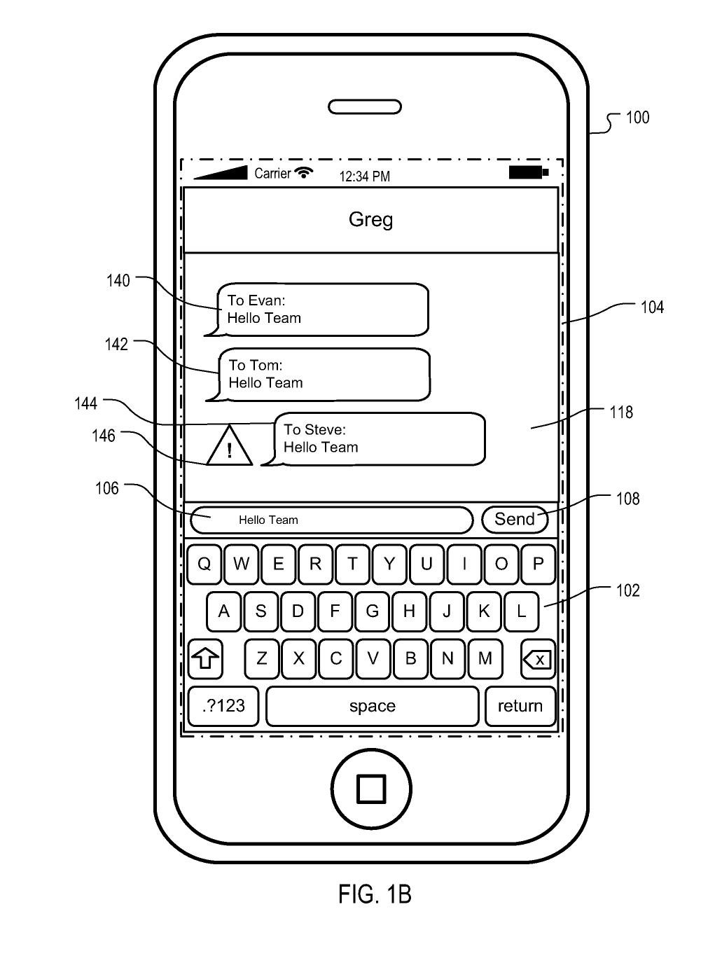

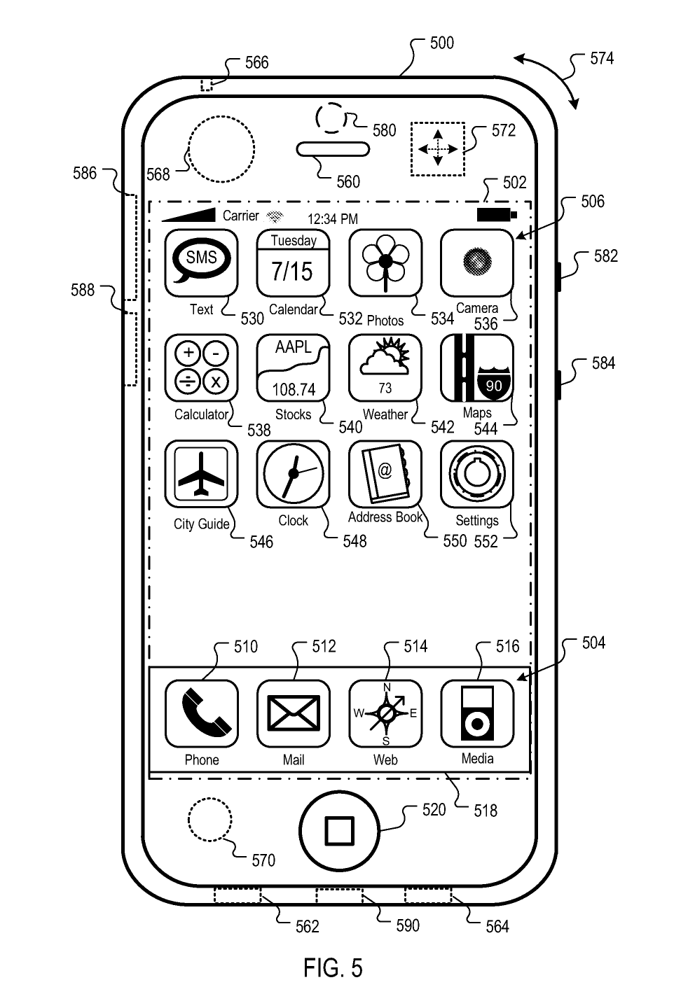

FIG. 1A shows an example portable device 100. For example, the portable device 100 can be a cellular phone, a personal digital assistant (PDA), or a portable media device (e.g., a portable MPEG-1 Audio Layer 3 (MP3) player, a portable DVD player, etc.). Some examples of the portable device 100 may be an iPhone™ or an iPod Touch™ manufactured by Apple Inc. (Cupertino, Calif.). Various software applications can be executed by the portable device 100, as will be described below with reference to FIG. 5. In the depicted example, the portable device 100 is executing an SMS messaging application.

The mobile device 100 can include a virtual keyboard 102 used in creating SMS messages. The virtual keyboard 102 includes keys corresponding to characters and symbols. The mobile device 100 can also include a touch-sensitive touch screen 104, as will be described further below. In one example, the user can select a character by touching a key corresponding to the character on the touch screen 104.

In one implementation, the touch screen 104 can include a text input field 106 for a user to compose an SMS message. The user can tap the desired keys on the virtual keyboard 102 and the message appears in the text input field 106. After composing the message, the user touches a user interface element (e.g., a send button 108) to send the message to one or more specified recipients. In the example of FIG. 1A, the user has sent three SMS messages, “Hello Mike,” 110, “Hello Steve,” 112, and “Hello Evan,” 114 to three different recipients. The messages 110, 112, and 114 are shown in “bubbles” in a message “chat” area 118 of the touch screen 104.

In one implementation, when a message transmission fails, an indicator 116 is displayed in the chat area 118 to indicate the failed transmission. In the example shown, the indicator 116 is an alert symbol. The indicator 116 can be displayed proximate to the “bubble” containing the message transmission that failed. In this example, the transmission of the message “Hello Evan” 114 failed and the indicator 116 is displayed to the left of the “bubble” to indicate the failure. In other implementations, the indicator 116 can be displayed to the right, below, or above the “bubble,” or presented at any other suitable location on the touch screen 104. In some implementations, failed transmission can be indicated using an audio message, force feedback or any desired combination of audio, visual and force feedback.

FIG. 1B shows an example portable device 100. In the example of FIG. 1B, the user has sent a multimessage to a group that includes more than one recipient. The multimessage is the same message sent to each recipient and is sent as one message. In the example of FIG. 1B, the user has sent one SMS message “Hello Team” to a group with three recipients, 140, 142, 144. The messages 140, 142, and 144 are shown in a “bubble” in the message “chat” area 118 of the touch screen 104.

In one implementation, when a message transmission to a group fails, an indicator 146 is displayed in the chat area 118 to indicate the failed transmission next to the recipient that failed. In the example shown, the indicator 146 can be displayed proximate to the “bubble” containing the message transmission that failed.

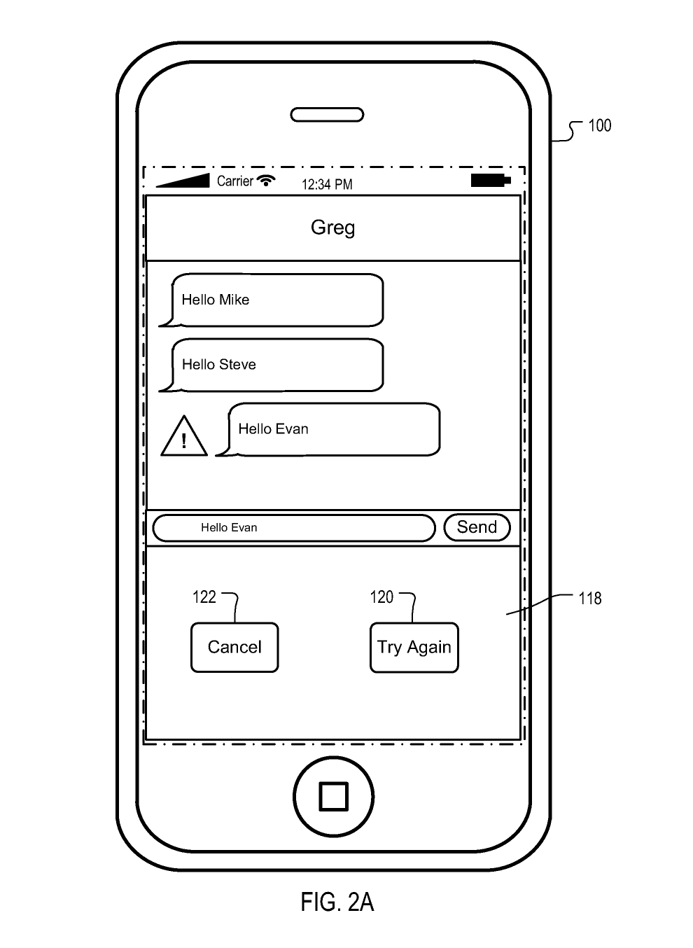

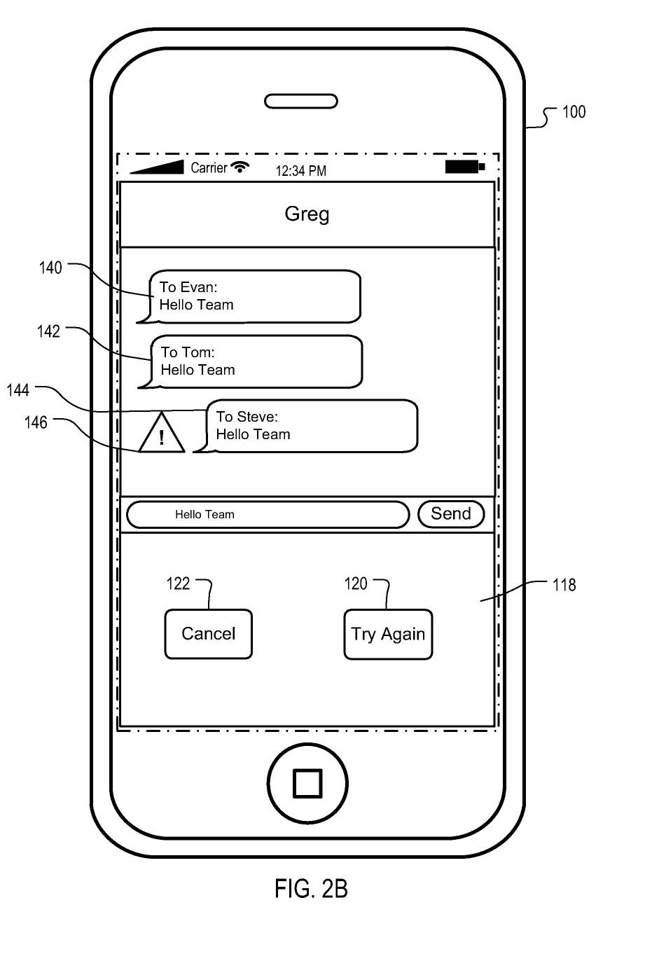

FIG. 2A is a block diagram of an example of a mobile device operable for resending a failed message. In one implementation, when a failed transmission is detected, the virtual keyboard is replaced by a retry screen 118. The retry screen 118 allows the user to resend the failed message. For example, when user clicks “Try Again” button 120, the message is resent to the specified recipient.

In one implementation, the mobile device 100 can store multiple failed messages and allow retransmission of selected failed messages. For example, if two of the transmissions shown in FIG. 1A failed, the chat area 118 of the mobile device would present indicators 116 next to their respective message balloons. Upon selection of either of the indicators 116 (e.g., by tapping the indicators), the user can be presented with a “Try Again” button 120 corresponding to the failed message indicator that was tapped.

In one implementation, the mobile device 100 can also allow the user to “Cancel” 122 the message transmission. If a message transmission failed, the user can select “Cancel” 122 and the message will be cancelled rather than retransmitted.

In one implementation, the mobile device 100 can provide functionality for the user to edit the failed message transmission. For example, the mobile device 100 can provide a text input field 106 and when the user selects the text area 106, the virtual keyboard 102 can reappear and the user can use the virtual keyboard 102 to change the message. The user can then use the mobile device 100 to send the new edited message. For example, the user can select the text input field 106 and change the “Hello Evan” message to something different and select the “send” button to send the new edited message. Thus the current state of the input text of the failed message is retained in the text input field 106 so that the user does not have to retype the entire message. Rather, the user need only complete the message the user was composing before the failed transmission.

FIG. 2B is a block diagram of another example of a mobile device operable for resending a failed message. In one implementation, when a failed transmission to a group is detected, or if the same message is sent to one or more users in one message, the virtual keyboard is replaced by a retry screen 118. The retry screen 118 allows the user to resend the failed message only to the recipient in the group that did not receive the message. For example, when user clicks “Try Again” button 120, the message is resent to all the recipients that the message did not reach. In this example, since the original message was sent to a group that included Evan, Tom, and Steve, the indicator 146 indicates the message did not reach Steve. The “Try Again” button 120 sends the message only to Steve because Steve was the only one in the group that did not receive the message.

In one implementation, upon selection of the indicator 146 (e.g., by tapping the indicators), the user can be presented with a “Try Again” button 120 corresponding to the failed message indicator that was tapped. The message would be sent to the recipient associated with the indicator 146. In this example, the message would be sent again to Steve, because the original message did not reach Steve.

In one implementation, the mobile device 100 can also allow the user to “Cancel” 122 the message transmission to the multiple recipients. If a message transmission to multiple recipients failed, the user can select “Cancel” 122 and the message will be cancelled rather than retransmitted to the recipient that did not receive the message.

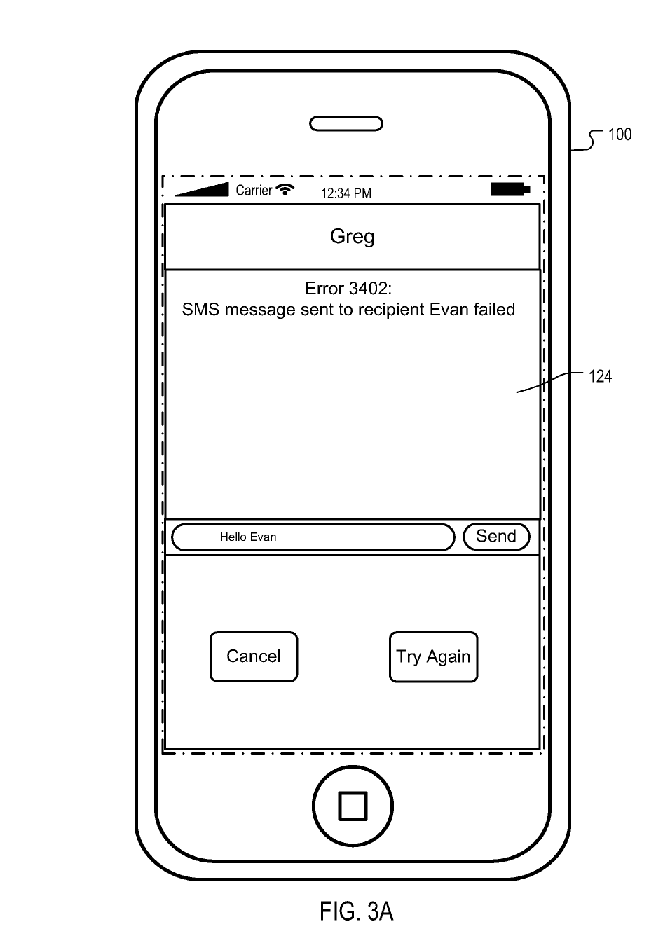

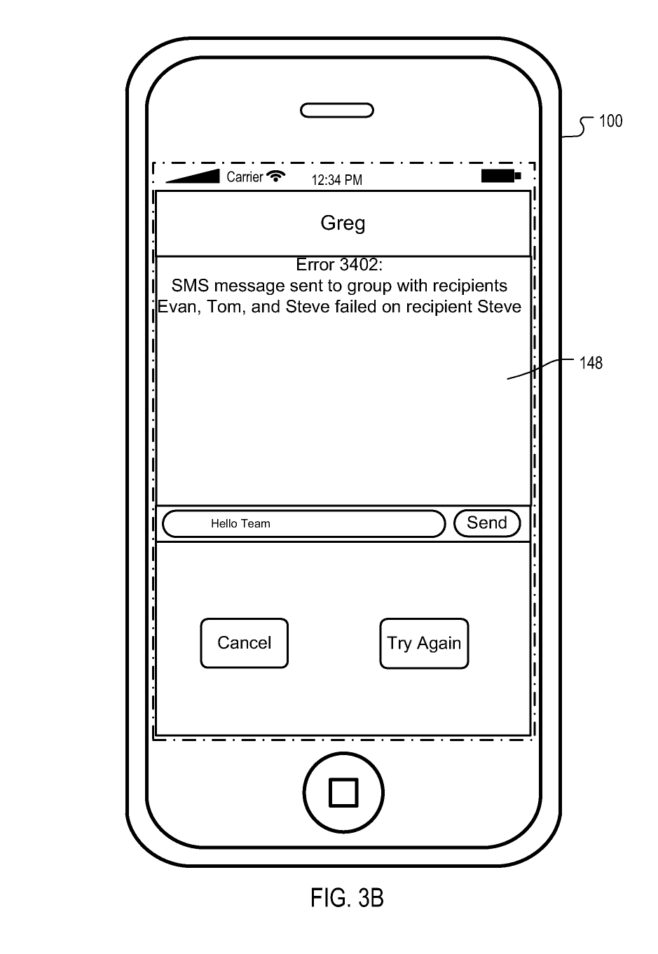

FIG. 3A is a block diagram of an example mobile device displaying an error report for a failed message transmission. In one implementation, when a user selects the indicator 106, an error report 124 is displayed for the user on the mobile device 100. When the indicator 106 is touched, the error report 124 can displace the previous screen as shown in FIG. 3A. The error report 124 displays the error as well as the recipient of the message associated with the error. In the example on FIG. 3A, the error report 124 states that “SMS message to recipient Evan failed” indicating that the SMS message intended for the recipient Evan was not successful.

FIG. 3B is a block diagram of an example mobile device displaying an error report for a failed message transmission to a group. In one implementation, when a user selects the indicator 146, an error report 148 is displayed for the user on the mobile device 100. When the indicator 146 is touched, the error report 148 can displace the previous screen as shown in FIG. 3B. The error report 148 displays the error as well as the recipient of the message associated with the error. In the example on FIG. 3B, the error report 124 states that “SMS message to group with recipients Evan, Tom, and Steve failed on recipient Steve” indicating that the SMS message intended for the group that contained Evan, Tom, and Steve was successful for Evan and Tom but not Steve. Therefore the SMS message did not reach Steve.

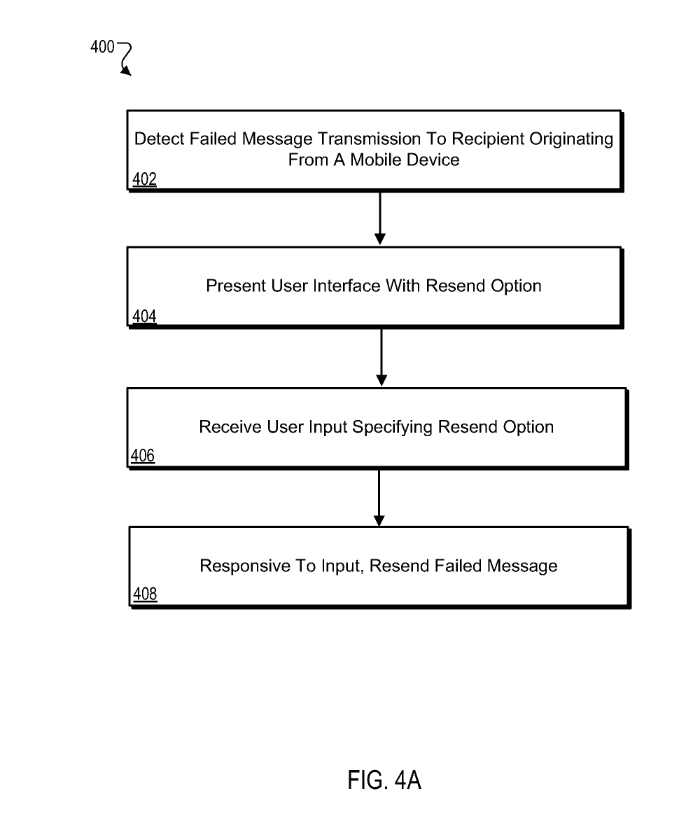

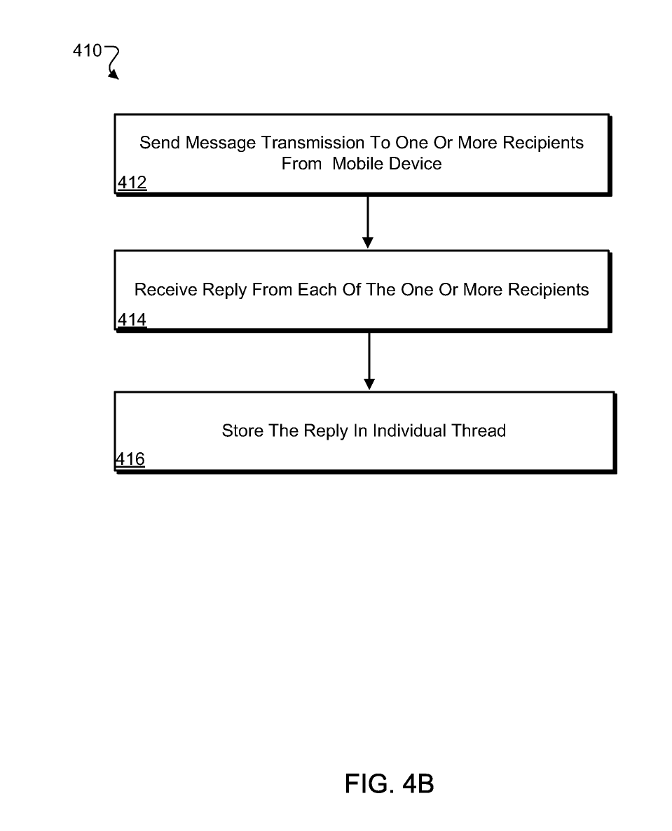

FIG. 4A is a flow diagram of a process 400 for resending messages on a mobile device. The process 400 begins when a failed message transmission is detected on a mobile device (402). The message transmission may have been sent to one or more recipients and one or more of the recipients may not have received the transmission. A user interface is presented on the mobile device, including a user interface element which is operable for specifying an option to resend the message to the recipient (404). A user interface can be presented on the mobile device for allowing the user to select any of a number of failed transmissions to be retransmitted. User input can be received specifying a resend option or cancel option (406). The message can be resent to the recipient upon receiving the resend option (408) and cancelled upon receiving the cancel option.

FIG. 4B is a flow diagram of an example process 410 for storing messages in one or more threads. The process 410 begins when a message transmission is sent to one or more recipients from a mobile device (412). The message transmission is stored in a group thread. A reply is received from each of the one or more recipients (414). The reply is stored in an individual thread associated with each of the one or more recipients (416).

### Mobile Device Overview

FIG. 5 is a block diagram of an example mobile device. In some implementations, the mobile device 500 includes a touch-sensitive display 502. The touch-sensitive display 502 can implement liquid crystal display (LCD) technology, light emitting polymer display (LPD) technology, or some other display technology. The touch-sensitive display 502 can be sensitive to haptic and/or tactile contact with a user.

In some implementations, the touch-sensitive display 502 can comprise a multi-touch-sensitive display 502. A multi-touch-sensitive display 502 can, for example, process multiple simultaneous touch points, including processing data related to the pressure, degree and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and U.S. Patent Publication 2002/0015024A1, each of which is incorporated by reference herein in its entirety.

In some implementations, the mobile device 500 can display one or more graphical user interfaces on the touch-sensitive display 502 for providing the user access to various system objects and for conveying information to the user. In some implementations, the graphical user interface can include one or more display objects 504, 506. In the example shown, the display objects 504, 506, are graphic representations of system objects. Some examples of system objects include device functions, applications, windows, files, alerts, events, or other identifiable system objects.

### Example Mobile Device Functionality

In some implementations, the mobile device 500 can implement multiple device functionalities, such as a telephony device, as indicated by a phone object 510; an e-mail device, as indicated by the e-mail object 512; a network data communication device, as indicated by the Web object 514; a Wi-Fi base station device (not shown); and a media processing device, as indicated by the media player object 516. In some implementations, particular display objects 504, e.g., the phone object 510, the e-mail object 512, the Web object 514, and the media player object 516, can be displayed in a menu bar 518. In some implementations, device functionalities can be accessed from a top-level graphical user interface, such as the graphical user interface illustrated in FIG. 5. Touching one of the objects 510, 512, 514 or 516 can, for example, invoke corresponding functionality.

In some implementations, the mobile device 500 can implement network distribution functionality. For example, the functionality can enable the user to take the mobile device 500 and its associated network while traveling. In particular, the mobile device 500 can extend Internet access (e.g., Wi-Fi) to other wireless devices in the vicinity. For example, mobile device 500 can be configured as a base station for one or more devices. As such, mobile device 500 can grant or deny network access to other wireless devices.

In some implementations, upon invocation of device functionality, the graphical user interface of the mobile device 500 changes, or is augmented or replaced with another user interface or user interface elements, to facilitate user access to particular functions associated with the corresponding device functionality. For example, in response to a user touching the phone object 510, the graphical user interface of the touch-sensitive display 502 may present display objects related to various phone functions; likewise, touching of the email object 512 may cause the graphical user interface to present display objects related to various e-mail functions; touching the Web object 514 may cause the graphical user interface to present display objects related to various Web-surfing functions; and touching the media player object 516 may cause the graphical user interface to present display objects related to various media processing functions.

In some implementations, the top-level graphical user interface environment or state of FIG. 5 can be restored by pressing a button 520 located near the bottom of the mobile device 500. In some implementations, each corresponding device functionality may have corresponding “home” display objects displayed on the touch-sensitive display 502, and the graphical user interface environment of FIG. 5 can be restored by pressing the “home” display object.

In some implementations, the top-level graphical user interface can include additional display objects 506, such as a short messaging service (SMS) object 530, a calendar object 532, a photos object 534, a camera object 536, a calculator object 538, a stocks object 540, a weather object 542, a maps object 544, a city guide object 546, a clock object 548, an address book object 550, and a settings object 552. Touching the SMS display object 530 can, for example, invoke an SMS messaging environment and supporting functionality; likewise, each selection of a display object 534, 536, 538, 540, 542, 544, 546, 548, 550 and 552 can invoke a corresponding object environment and functionality.

Additional and/or different display objects can also be displayed in the graphical user interface of FIG. 5. For example, if the device 500 is functioning as a base station for other devices, one or more “connection” objects may appear in the graphical user interface to indicate the connection. In some implementations, the display objects 506 can be configured by a user, e.g., a user may specify which display objects 506 are displayed, and/or may download additional applications or other software that provides other functionalities and corresponding display objects.

In some implementations, the mobile device 500 can include one or more input/output (I/O) devices and/or sensor devices. For example, a speaker 560 and a microphone 562 can be included to facilitate voice-enabled functionalities, such as phone and voice mail functions. In some implementations, a loud speaker 564 can be included to facilitate hands-free voice functionalities, such as speaker phone functions. An audio jack 566 can also be included for use of headphones and/or a microphone.

In some implementations, a proximity sensor 568 can be included to facilitate the detection of the user positioning the mobile device 500 proximate to the user's ear and, in response, to disengage the touch-sensitive display 502 to prevent accidental function invocations. In some implementations, the touch-sensitive display 502 can be turned off to conserve additional power when the mobile device 500 is proximate to the user's ear.

Other sensors can also be used. For example, in some implementations, an ambient light sensor 570 can be utilized to facilitate adjusting the brightness of the touch-sensitive display 502. In some implementations, an accelerometer 572 can be utilized to detect movement of the mobile device 500, as indicated by the directional arrow 574. Accordingly, display objects and/or media can be presented according to a detected orientation, e.g., portrait or landscape. In some implementations, the mobile device 500 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 500 or provided as a separate device that can be coupled to the mobile device 100 through an interface (e.g., port device 590) to provide access to location-based services.

The mobile device 500 can also include a camera lens and sensor 580. In some implementations, the camera lens and sensor 580 can be located on the back surface of the mobile device 500. The camera can capture still images and/or video.

The mobile device 500 can also include one or more wireless communication subsystems, such as a 802.11b/g communication device 586, and/or a Bluetooth™ communication device 588. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

In some implementations, a port device 590, e.g., a Universal Serial Bus (USB) port, or a docking port, or some other wired port connection, can be included. The port device 590 can, for example, be utilized to establish a wired connection to other computing devices, such as other communication devices 500, network access devices, a personal computer, a printer, or other processing devices capable of receiving and/or transmitting data. In some implementations, the port device 590 allows the mobile device 500 to synchronize with a host device using one or more protocols, such as, for example, the TCP/IP, HTTP, UDP and any other known protocol.

### Network Operating Environment

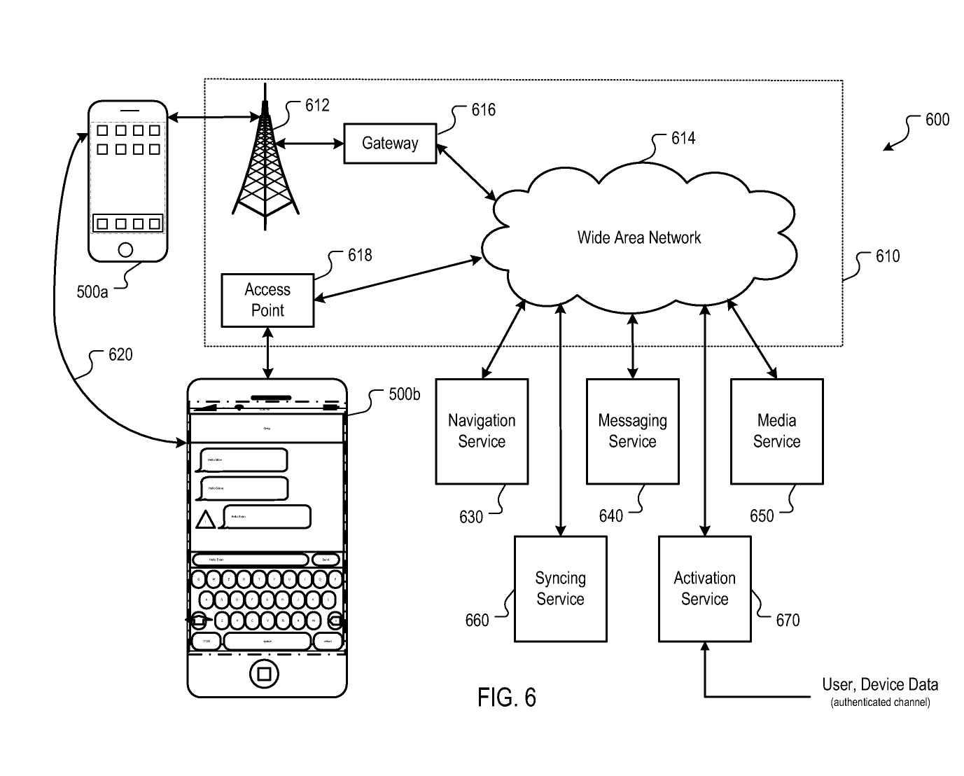

FIG. 6 is a block diagram of an example network operating environment 600 for the mobile device 500 of FIG. 5. The mobile device 500 of FIG. 5 can, for example, communicate over one or more wired and/or wireless networks 210 in data communication. For example, a wireless network 612, e.g., a cellular network, can communicate with a wide area network (WAN) 614, such as the Internet, by use of a gateway 616. Likewise, an access point 618, such as an 802.11g wireless access point, can provide communication access to the wide area network 614. In some implementations, both voice and data communications can be established over the wireless network 612 and the access point 618. For example, the mobile device 500a can place and receive phone calls (e.g., using VoIP protocols), send and receive e-mail messages (e.g., using POP3 protocol), and retrieve electronic documents and/or streams, such as web pages, photographs, and videos, over the wireless network 612, gateway 616, and wide area network 614 (e.g., using TCP/IP or UDP protocols). Likewise, the mobile device 500b can place and receive phone calls, send and receive e-mail messages, and retrieve electronic documents over the access point 618 and the wide area network 614. In some implementations, the mobile device 500 can be physically connected to the access point 618 using one or more cables and the access point 618 can be a personal computer. In this configuration, the mobile device 500 can be referred to as a “tethered” device.

The mobile devices 500a and 500b can also establish communications by other means. For example, the wireless device 500a can communicate with other wireless devices, e.g., other wireless devices 100, cell phones, etc., over the wireless network 612. Likewise, the mobile devices 500a and 500b can establish peer-to-peer communications 620, e.g., a personal area network, by use of one or more communication subsystems, such as the Bluetooth™ communication device 588 shown in FIG. 5. Other communication protocols and topologies can also be implemented.

The mobile device 100 can, for example, communicate with one or more services 630, 640, 650, 660, and 670 over the one or more wired and/or wireless networks 610. For example, a navigation service 630 can provide navigation information, e.g., map information, location information, route information, and other information, to the mobile device 100.

A messaging service 640 can, for example, provide e-mail and/or other messaging services. A media service 650 can, for example, provide access to media files, such as song files, movie files, video clips, and other media data. A syncing service 660 can, for example, perform syncing services (e.g., sync files). An activation service 670 can, for example, perform an activation process 500 for activating the mobile device 500, as described in reference to FIG. 5. Other services can also be provided, including a software update service that automatically determines whether software updates exist for software on the mobile device 500, then downloads the software updates to the mobile device 500 where it can be manually or automatically unpacked and/or installed.

The mobile device 500 can also access other data and content over the one or more wired and/or wireless networks 610. For example, content publishers 670, such as news sites, RSS feeds, web sites, blogs, social networking sites, developer networks, etc., can be accessed by the mobile device 500. Such access can be provided by invocation of a web browsing function or application (e.g., a browser) in response to a user touching the Web object 514.

### Example Mobile Device Architecture

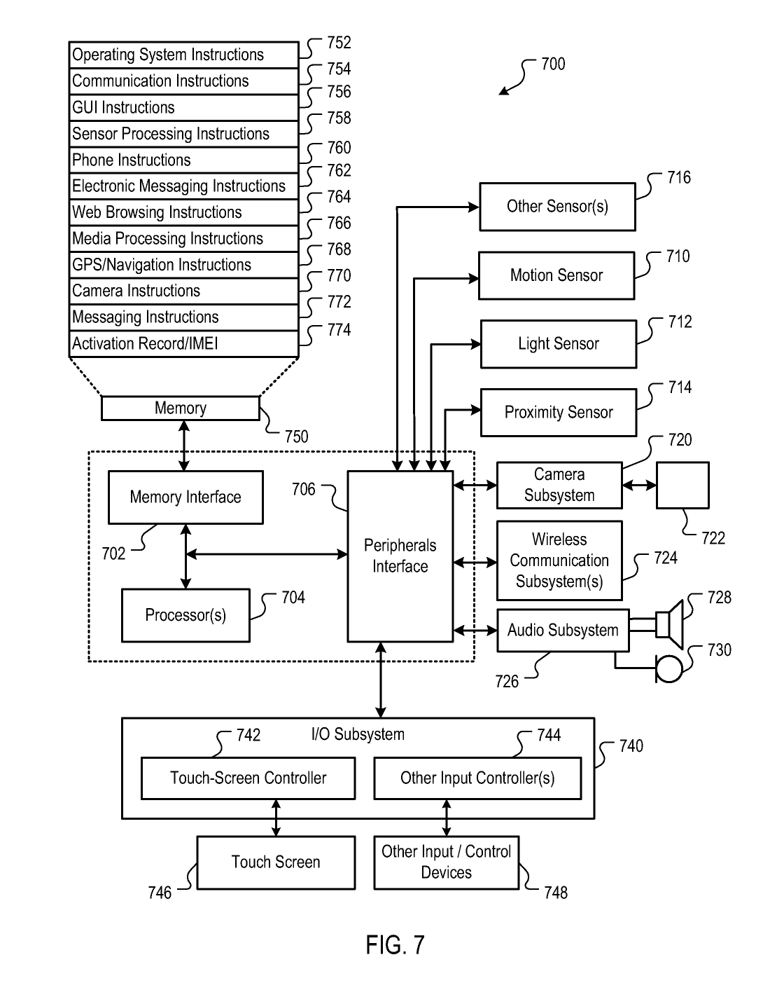

FIG. 7 is a block diagram 700 of an example implementation of the mobile device 500 of FIG. 5. The mobile device 500 can include a memory interface 702, one or more data processors, image processors and/or central processing units 704, and a peripherals interface 706. The memory interface 702, the one or more processors 704 and/or the peripherals interface 706 can be separate components or can be integrated in one or more integrated circuits. The various components in the mobile device 500 can be coupled by one or more communication buses or signal lines.

Sensors, devices and subsystems can be coupled to the peripherals interface 706 to facilitate multiple functionalities. For example, a motion sensor 710, a light sensor 712, and a proximity sensor 714 can be coupled to the peripherals interface 706 to facilitate the orientation, lighting and proximity functions described with respect to FIG. 5. Other sensors 716 can also be connected to the peripherals interface 706, such as a positioning system (e.g., GPS receiver), a temperature sensor, a biometric sensor, or other sensing device, to facilitate related functionalities.

A camera subsystem 720 and an optical sensor 722, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 724, which can include radio frequency receivers and transmitters and/or optical (e.g., infrared) receivers and transmitters. The specific design and implementation of the communication subsystem 724 can depend on the communication network(s) over which the mobile device 500 is intended to operate. For example, a mobile device 500 may include communication subsystems 724 designed to operate over a GSM network, a GPRS network, an EDGE network, a Wi-Fi or WiMax network, and a Bluetooth™ network. In particular, the wireless communication subsystems 724 may include hosting protocols such that the device 500 may be configured as a base station for other wireless devices.

An audio subsystem 726 can be coupled to a speaker 728 and a microphone 730 to facilitate voice-enabled functions, such as voice recognition, voice replication, digital recording, and telephony functions.

The I/O subsystem 740 can include a touch screen controller 742 and/or other input controller(s) 744. The touch-screen controller 742 can be coupled to a touch screen 746. The touch screen 746 and touch screen controller 742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 746.

The other input controller(s) 744 can be coupled to other input/control devices 748, such as one or more buttons, rocker switches, thumb-wheel, infrared port, USB port, and/or a pointer device such as a stylus. The one or more buttons (not shown) can include an up/down button for volume control of the speaker 728 and/or the microphone 730.

In one implementation, a pressing of the button for a first duration may disengage a lock of the touch screen 746; and a pressing of the button for a second duration that is longer than the first duration may turn power to the mobile device 500 on or off. The user may be able to customize a functionality of one or more of the buttons. The touch screen 746 can, for example, also be used to implement virtual or soft buttons and/or a keypad or keyboard.

In some implementations, the mobile device 500 can present recorded audio and/or video files, such as MP3, AAC, and MPEG files. In some implementations, the mobile device 500 can include the functionality of an MP3 player, such as an iPod™. The mobile device 500 may, therefore, include a 36-pin connector that is compatible with the iPod. Other input/output and control devices can also be used.

The memory interface 702 can be coupled to memory 750. The memory 750 can include high-speed random access memory and/or non-volatile memory, such as one or more magnetic disk storage devices, one or more optical storage devices, and/or flash memory (e.g., NAND, NOR). The memory 750 can store an operating system 752, such as Darwin, RTXC, LINUX, UNIX, OS X, WINDOWS, or an embedded operating system such as VxWorks. The operating system 752 may include instructions for handling basic system services and for performing hardware dependent tasks.

The memory 750 may also store communication instructions 754 to facilitate communicating with one or more additional devices, one or more computers and/or one or more servers. The memory 750 may include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes and instructions; camera instructions 770 to facilitate camera-related processes and functions; and/or other messaging instructions 772 to facilitate processes and functions, as described in reference to FIGS. 1-4.

Each of the above identified instructions and applications can correspond to a set of instructions for performing one or more functions described above. These instructions need not be implemented as separate software programs, procedures or modules. The memory 750 can include additional instructions or fewer instructions. Furthermore, various functions of the mobile device 500 may be implemented in hardware and/or in software, including in one or more signal processing and/or application specific integrated circuits.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method, comprising:
detecting a failed message transmission to a recipient originating on a mobile device;
presenting a user interface on the mobile device, including a user interface element which is operable for specifying an option to resend the message to the recipient;
receiving user input specifying the resend option; and
resending the message to the recipient.

2. The method of claim 1, further comprising:
presenting on the user interface an indicator for indicating the failed message.

3. The method of claim 2, further comprising:
presenting on the user interface an error report associated with the failed message transmission.

4. The method of claim 1, further comprising:
presenting the failed message;
receiving input editing the failed message; and
resending the edited failed message.

5. A method, comprising:
sending a message transmission to a group, wherein the group includes one or more recipients on a mobile device;
detecting a failed message transmission to one of the one or more recipients in the group;
presenting a user interface on the mobile device, including a user interface element which is operable for specifying an option to resend the message to the one of the one or more recipients;
receiving user input specifying the resend option; and
resending the message to the one of the one or more recipients.

6. The method of claim 5, further comprising:
presenting on the user interface an indicator for indicating the failed message.

7. The method of claim 6, further comprising:
presenting on the user interface an error report associated with the failed message transmission.

8. A method, comprising:
sending a message transmission to one or more recipients from a mobile device, wherein the message transmission is stored in a group thread;
receiving a reply from each of one or more recipients; and
storing the reply in an individual thread associated with each of the one or more recipients.

9. A system comprising:
a processor;
a computer-readable medium coupled to the processor and having instructions stored thereon, which, when executed by the processor, causes the processor to perform operations comprising:
detecting a failed message transmission to a recipient originating on a mobile device;
presenting a user interface on the mobile device, including a user interface element which is operable for specifying an option to resend the message to the recipient;
receiving user input specifying the resend option; and
resending the message to the recipient.

10. The system of claim 9, further comprising operations including:
presenting on the user interface an indicator for indicating a failed message.

11. The system of claim 9, further comprising operations including:
presenting on the user interface an error report associated with the failed message transmission.

12. The system of claim 9, further comprising operations including:
presenting the failed message;
receiving input editing the failed message; and
resending the edited failed message.

13. A system comprising:
a processor;
a computer-readable medium coupled to the processor and having instructions stored thereon, which, when executed by the processor, causes the processor to perform operations comprising:
sending a message transmission to one or more recipients from a mobile device, wherein the message transmission is stored in a group thread;
receiving a reply from each of one or more recipients; and
storing the reply in an individual thread associated with each of the one or more recipients.

14. A system, comprising:
means for detecting a failed message transmission to a recipient originating on a mobile device;
means for presenting a user interface on the mobile device, including a user interface element which is operable for specifying an option to resend the message to the recipient;
means for receiving user input specifying the resend option; and
means for resending the message to the recipient.
